(19) United States
(12) Patent Application Publication
(10) Pub. No.: US 2006/0111952 A1
(43) Pub. Date: May 25, 2006

(54) Method of qualifying small business ownership for first-time buyers

(76) Inventors: Joseph Patrick McCaul, Naperville, IL (US); Kenneth Michael McCaul, Naperville, IL (US)

Correspondence Address: MCGUIREWOODS, LLP, 1750 TYSONS BLVD, SUITE 1800, MCLEAN, VA, 22102, US

(21) Appl. No.: 11/272,078

(22) Filed: Nov. 14, 2005

Related U.S. Application Data
(60) Provisional application No. 60/630,237, filed on Nov. 24, 2004.

(51) Int. Cl. G06F 9/44; G06F 17/50

(52) U.S. Cl. 705/7

(57) ABSTRACT

A business brokerage process is provided for identifying key issues for locating appropriate buyers and sellers for a successful business purchase. The method includes the steps of psychological testing, process awareness through coaching and education, spousal support through involvement, and access to financing through introduction to providers of capital.

### CLAIM OF PRIORITY BASED ON PROVISIONAL APPLICATION

This application claims priority based on the provisional application filed in the U.S. Patent and Trademark Office on Nov. 24, 2004, having Ser. No. 60/630,237, by the same inventors and having the same title as this application.

### FIELD OF THE INVENTION

The present invention relates to buying and selling of businesses, and more particularly, to a method of qualifying appropriate potential first-time business buyers and matching those qualified potential buyers with appropriate businesses for them to acquire.

### BACKGROUND OF THE PRESENT INVENTION

Many executives at the peak of their career are facing either a lack of opportunity or potential transition for reasons beyond their control. Demographics have created a bubble of baby-boomers with no where to go in organizations that have undergone “flattening” and “de-layering.” For those with the highest drive and ability, this situation may become intolerable. Seeking alternatives, many decide that they want to buy a business. Their vision places them as captain of their own ship and master of their own destiny. With this thought in mind, most will then contact a business broker.

Business brokers have largely avoided establishing a client (fiduciary) relationship with first-time buyers because it was unprofitable for them to do so. Most such prospects never in their lifetime buy a business. Industry sources estimate that fewer than one in twelve such individuals contacting a business broker ever consummate a sale. Given these odds, a broker will likely be presenting opportunities to the buyer-client who then does not act. Without a sale, there is no broker commission. The common countermeasure is for the broker to charge a non-refundable engagement fee. This shifts financial risk to the client. To be effective in demonstrating motivation, the engagement fees must be substantial. The unintended result is to turn away otherwise good prospects. Even the best prospects lack information on the various aspects of buying a business. This diminishes their effectiveness and further deteriorates an already serious problem.

As an industry, the vast majority of business brokers focus on listing businesses for sale as representatives of the owners. A broker expects to work with a large number of buyers, but has the assurance that a commission is payable if he is the procuring cause of an offer meeting the agreed listing price. Similar to real estate transactions, a commission can be payable without the necessity of consummating a sale.

Many brokers who do work with buyers are typically showing these individuals their listed inventory. The broker's fiduciary responsibility is therefore to the seller. Others perform searches among other brokers' listings, hoping to split a commission (co-brokering). Few perform actual searches among unlisted businesses while maintaining a fiduciary responsibility to the buyer throughout the process. These searches typically performed are mailings of generic letters to recipients named on purchased mailing lists. These letters usually elicit a response rate of less than 1%. Follow up phone calls can sharply increase the engagement rate, but are rarely undertaken due to the expense. Given all these problems, buyer representation has not taken a foothold in business brokerage yet.

For many prospective buyers, searching for a business is a very serious undertaking, especially since they are often in career transition. They are typically at an age and career level where it will be difficult for them to replace the executive level position they once had. Buying a business may be the only viable alternative for them to replace their lost income. Unfortunately, they face a daunting series of challenges in their quest of business ownership. Many have little or no hope of success, but lack the information needed for them to make that determination for themselves. This knowledge deficiency causes them to misdirect their time and remaining cash into a search for a business when they should be looking for a job. After months of effort, they learn that they lack adequate capital, can't attract financing in their desired industry, or realize that either they or their spouse cannot accept the inherently high risks of entrepreneurship. The list of entrepreneur risks is a long one. Nevertheless, their fruitless efforts may compound personal adversity into tragedy.

Those buyers who do fit the mold of an entrepreneur have a difficult time finding suitable businesses to buy. Of those firms listed for sale in an appropriate size range (usually revenues $500K-$2.5 million), only one in five will actually be sold. The reason for this is often that the business is over-priced. Brokers accept such listings hoping that the owners will reduce their asking price once market value has been tested. Brokers might have thought a synergistic buyer could emerge and pay above Fair Market Value. Very often, defects become known after a listing has been accepted or business performance slumps unexpectedly. The net result is that most listed businesses are not worthwhile opportunities for a first-time buyer. Those few that are attractive may not make it to the broader market before being quickly acquired. The few good ones remaining may not match the buyer's industry, geographic or other criteria. His only hope is just that - hope. Random chance may provide a good deal for him.

Accordingly, the market is dominated by prospective buyers that don't yet realize their lack of fit as entrepreneurs. The buyers that might make great business owners have limited chance of success in finding a suitable business to buy at a fair price. They further lack process knowledge and professional contacts that could increase the probability and magnitude of their future success. The brokers who will work with these individuals are often retain fiduciary responsibility to the sellers, use search methods that are ineffective and transfer risk to the buyers through high engagement fees.

### OBJECTS AND SUMMARY OF THE INVENTION

In view of the foregoing, an object of the present invention is to provide a method enabling a business broker to more accurately and reliably select highly qualified first-time buyers and match those buyers with appropriate businesses for them to acquire.

In accordance with the method of the present invention, a business brokerage process is provided for identifying key issues for locating appropriate buyers and sellers for a successful business purchase. Potential insurmountable issues are placed forward in the fee-based process (Credentialing®) for efficient qualification of prospects. They include self-awareness through psychological testing and risk tolerance assessment, process awareness through coaching and education, spousal support through involvement and access to financing through introduction to providers of capital. Efficiency and accessibility are achieved through use of an on-line psychological assessment and videotaped, seminar-based education. Spouses are encouraged to view the films and attend the regularly scheduled live seminars. Prospects are then introduced to sources of financing and instructed to get a letter of pre-qualification.

The second phase of the process is the actual search for a business to buy. The typical buyer only has access to those businesses being actively marketed. Of those businesses, only a small number will match the buyer' criteria for industry, size, location, profitability, etc. Of those firms listed for sale, only one in five will typically be sold. Once this small pool has been exhausted, the buyers are then waiting for opportunities to emerge one-by-one forcing them to wait and then compete with the other buyers for the rare viable deal.

The search process developed seeks to find acquisitions among those businesses not listed for sale. The process is batch rather than sequential. This reduces the average time required to achieve a successful conclusion, and creates a “reverse auction” environment favorable to the buyer and makes a successful outcome highly probable.

Commercial databases are used to identify firms matching the criteria developed by the buyers. The information is then reorganized into a format that allows the buyer to review and either accept or reject each candidate. A typical attrition rate at this step is 30%. The remaining targets are contacted by the broker using direct mail. The envelope and letters have several key features that generate a 5% response rate. The envelope features include: (1) a fully printed and stamped envelope (no labels); and (2) the word “confidential” printed and highlighted on the envelope. The letter features include: (1) a first paragraph uniquely identifying a specific buyer and their requirements; (2) use of mail merge fields to specify the requirement subsets as direct matches to the targets' industry and other characteristics; (3) broker references; (4) assurance of confidentiality; and (5) a range of methods for the recipient to initiate contact including phone, fax, email, and prepaid business reply mailers.

Follow-up phone calls will reliably increase the engagement rate to 10% or higher. The incremental response rate however is among the business owners having demonstrated lower motivation.

Upon direct contact, opportunities are screened by the broker to eliminate any candidates who do not match the client's criteria and are not realistic in their expectations, motivated to sell and capable of doing so. Site visits and preliminary analysis further reduce the pool of candidates to 1% of the letter recipients. Negotiations are initiated with the most desirable target. If a closing cannot be achieved, the alternate candidates are approached in rank order of attractiveness. One approach in three is typically successful. Statistical analysis therefore indicates a 94% probability of success if the starting pool size is 1000 targets.

A further refinement of the search process is the multi-client variant (Wolf Pack™). Retainers are typically used to force buyers to demonstrate their motivations as the risk to the broker is the buyer chooses not to buy. Successful completion of the Credentialing® process in itself demonstrates motivation. Pooling of searches is enabled by buyers' general lack of target specificity and agreement to disengage from targets of no interest. These targets may be of great interest to a client in a concurrent search. This allows searches with either fewer unique targets per client or a higher probability of success.

### BRIEF DESCRIPTION OF THE DRAWINGS

FIG. 1 is a flow chart of the Credentialing process configured in accordance with the present invention;

FIG. 2 is a flow chart of the Wolf Pack™ Multi-Client search process configured in accordance with the present invention;

FIG. 3 is a flow chart of the Single-Client search process configured in accordance with the present invention;

FIG. 4 is a chart illustrating detailed sub-steps within Initial Broker Preparation and First Contacts steps of the Credentialing process shown in FIG. 1;

FIG. 5 is a chart illustrating detailed sub-steps within Buyer Preparation for Office Visit, Broker Preparation for Office Visit, and Office Visit steps of the Credentialing process shown in FIG. 1;

FIG. 6 is a chart illustrating detailed sub-steps within Seminar and Pre-Qualify for Small Business Administration (SBA) Financing steps of the Credentialing process shown in FIG. 1;

FIG. 7 is chart illustrating detailed sub-steps within Execute Purchaser Fee Agreement, Finalize Clients' Target Criteria, Allocate Duplicate Selections, and Client Culling of Target steps of the Wolf-Pack™ Multi-Client search process shown in FIG. 2;

FIG. 8 is chart illustrating detailed sub-steps within Broker Cleaning and Loading of Data, Prepare Templates and Mail Letters, Broker Handles Replies, and Call Target steps of the Wolf-Pack™ Multi-Client search process shown in FIG. 2;

FIG. 9 is chart illustrating detailed sub-steps within Buyer Feedback, Selection of Target Finalists, Pursuit of Top Candidate, Deal Closes, Unclaimed Target Pool, and Target Closure steps of the Wolf-Pack™ Multi-Client search process shown in FIG. 2;

FIG. 10 is a chart illustrating detailed sub-steps within Execute Purchaser Fee Agreement, Determine Clients' Target Criteria, Client Culling of Targets, and Broker Cleaning and Loading of Data steps of the Single-Client search process shown in FIG. 3;

FIG. 11 is a chart illustrating detailed sub-steps within Prepare Templates and Mail Letters, Broker Handle Replies, and Call Targets steps of the Single-Client search process shown in FIG. 3;

FIG. 12 is a chart illustrating detailed sub-steps within Buyer Feedback, Selection of Target Finalists, Pursuit of Top Candidate, Deal Closes, and Target Closure steps of the Single-Client search process shown in FIG. 3;

FIG. 13 is a methodology diagram of risk of business ownership configured in accordance with the present invention;

FIG. 14 is a calculation spreadsheet corresponding to the diagram of FIG. 13; and

FIG. 15 is a sample script for use in the Wolf-Pack™ Multi-Client and Single-Client search process shown in FIG. 2.

### DETAILED DESCRIPTION OF THE PREFERRED EMBODIMENT

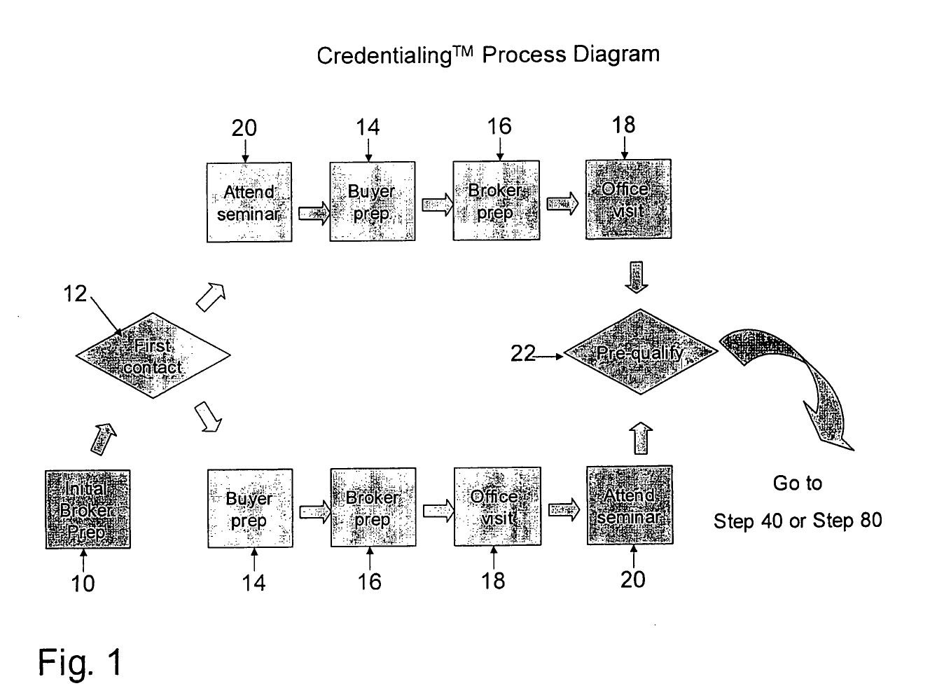

Referring to the drawings, FIG. 1 is a flow chart or flow diagram of the Credentialing® process configured in accordance with the present invention. The Credentialing® process or method begins at step 10 wherein a broker begins initial broker preparation. Afterwards at step 12, a first contact is made with a potential buyer, wherein the potential buyer can either attend a seminar at step 20 or go immediately to buyer preparation at step 14. The preferred method is for the buyer to attend the live seminar in step 20 before undertaking the buyer preparation steps in step 14, but if there is no live buyer seminar scheduled to happen within a short timeframe, the buyer may elect to view the previously filmed series on DVD. If the buyer goes directly to the seminar at step 20, the potential buyer participates sequentially in the following steps of buyer preparation 14, broker preparation 16, office visit 18, and pre-qualifying step 22.

If the potential buyer initially went to the buyer preparation step 14 after first contact step 12, the potential buyer participates sequentially in broker preparation step 16, office visit step 18, attend seminar step 20, and pre-qualify step 22.

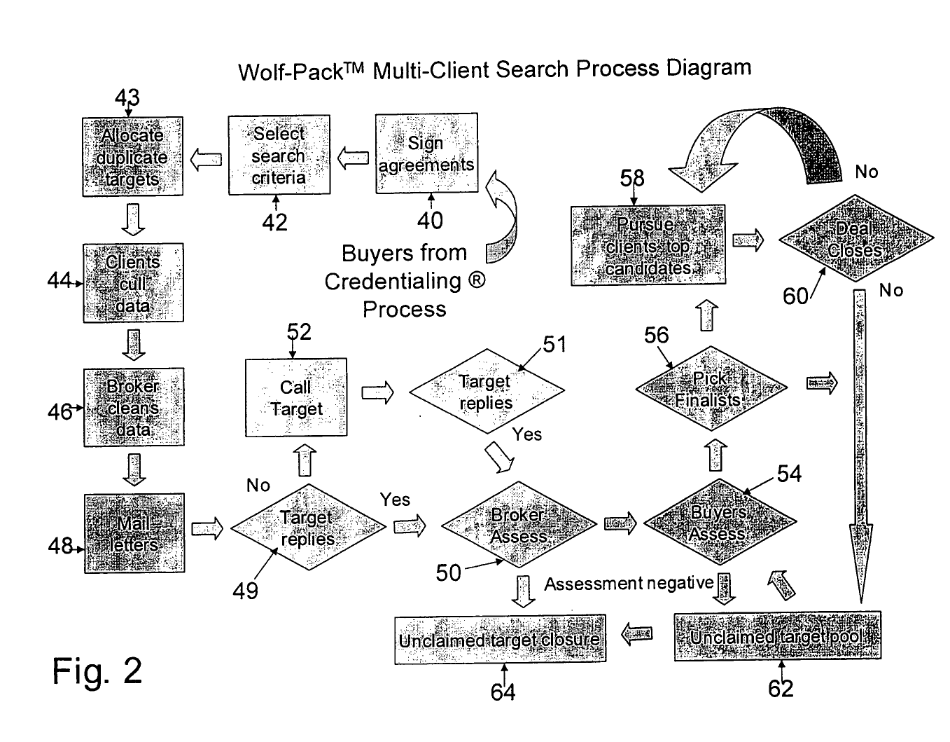

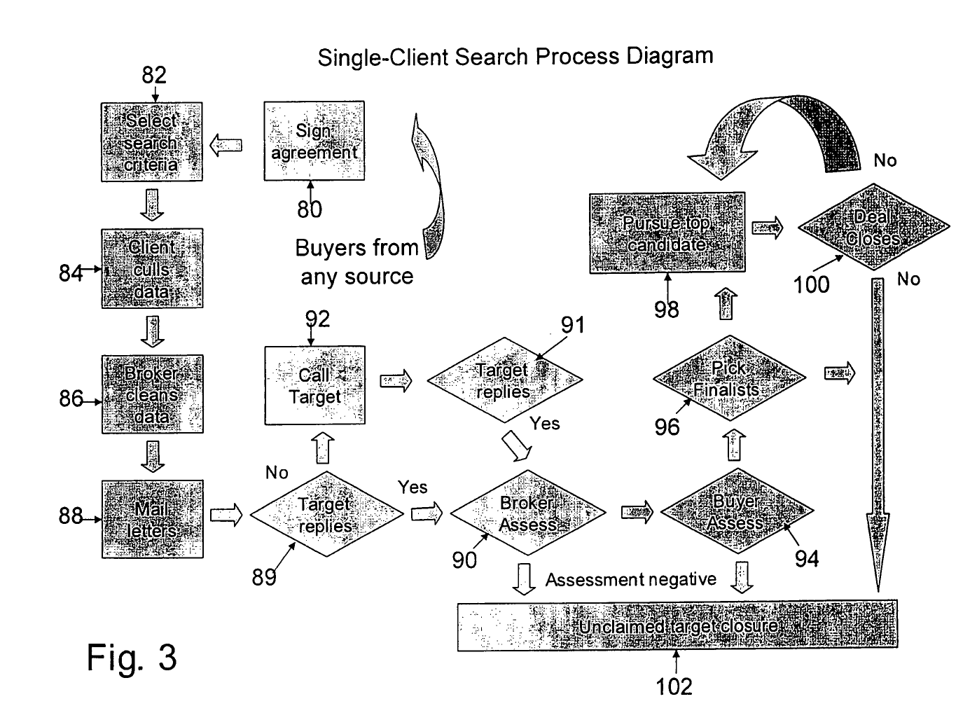

FIGS. 2 and 3 illustrate the Wolf-Pack™ Multi-Client search process and the Single-Client search process, respectively. After pre-qualify step 22 of the Credentialing® process, a potential buyer will go either to sign agreements step 40 of the Wolf-Pack™ Multi-Client search process or sign agreement step 80 of the Single-Client search process. The decision on whether to join the Wolfpack is dependent on the specific needs of the buyer. If those needs are unique (ex. Out-of-state search) a single client search would be appropriate. A single client search would also be required for first time buyers who have not elected to go through the Credentialing® process.

If the potential buyer goes to the sign agreements step 40 of the Wolf-Pack™ Multi-Client search process, the buyer next goes through the sequential steps of select search criteria 42, allocate duplicate targets 43, client cull data 44, broker cleans data 46, mail letters 48, and target replies 49. At step 49 the target independently elects to respond or not. If not, the broker may elect at step 52 to call those targets who have not responded within about five working days. Those targets who have responded whether proactively in step 49 or reactively in step 51 are assessed by the broker in step 50.

At broker assess step 50, the target goes either to buyer assess step 54 or unclaimed target closure step 64 based on broker's judgment of target's suitability. If the target goes to buyer assess step 54, the target next goes to either unclaimed target pool step 62 or pick finalist step 56 based on buyer's assessment of desirability. If the target goes to the unclaimed target pool step 62, the target can then be made available to other concurrent buyer searches at their own step 54. If unclaimed by any other buyer, the target then moves to step 64 unclaimed target closures. For the Pick Finalist step 56, the buyer chooses and prioritizes their top candidates and proceeds to pursue them sequentially in rank order in step 58.

If the pursuit is successful, the deal closes in step 60 and all remaining targets are placed in the unclaimed target pool in step 62. If the deal does not close, the buyer selects the next target to pursue and repeats step 60. If the potential buyer moves to the sign agreement step 80 of the Single Client search process from either First Contact step 12 or pre-qualify step 22, the next sequential steps are select search criteria 82, client culls data 84, broker cleans data 86, mail letters 88, and target replies 89.

At step 89 the target independently elects to respond or not. If not, the broker may elect at step 92 to call those targets who have not responded within five working days. Those targets who have responded whether proactively in step 89 or reactively in step 91 are assessed by the broker in step 90.

At broker assess step 90, the target goes either to buyer assess step 94 or unclaimed target closure step 102 based on broker's judgment of target's suitability. If the target goes to buyer assess step 94, the target next goes to either unclaimed target closure step 102 or pick finalist step 96 based on buyer's assessment of desirability. For the Pick Finalist step 96, the buyer chooses and prioritizes their top candidates and proceeds to pursue them sequentially in rank order in step 98. If the pursuit is successful, the deal closes in step 100 and all remaining targets are placed in the unclaimed target closure in step 102. If the deal does not close the buyer selects the next target to pursue and repeats step 60.

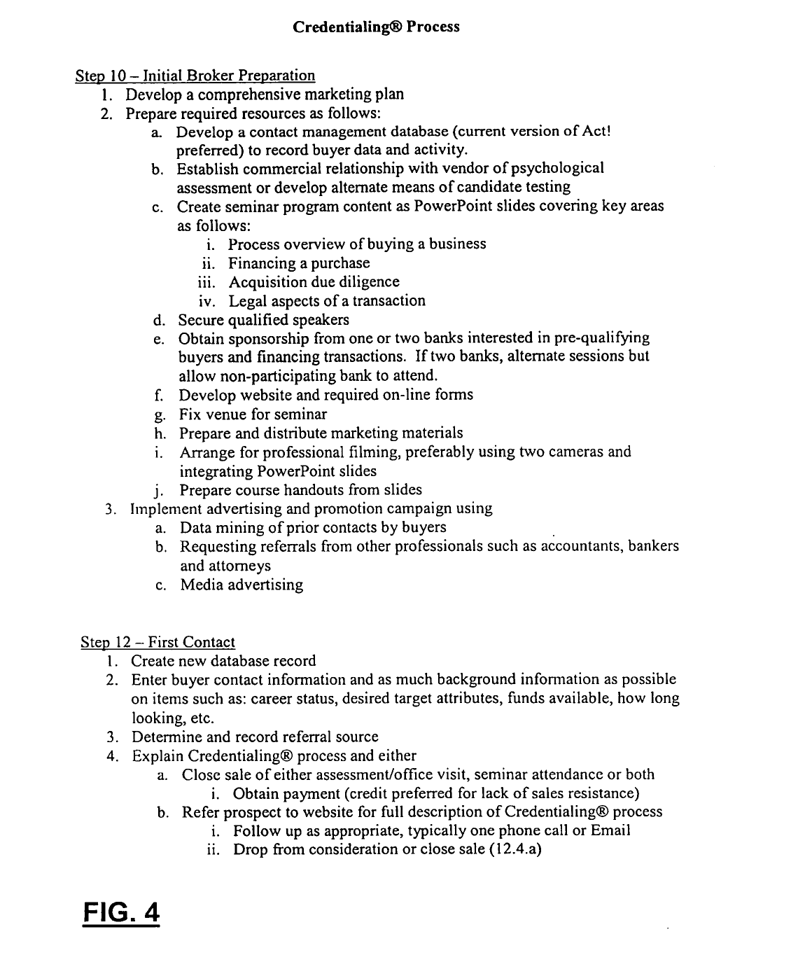

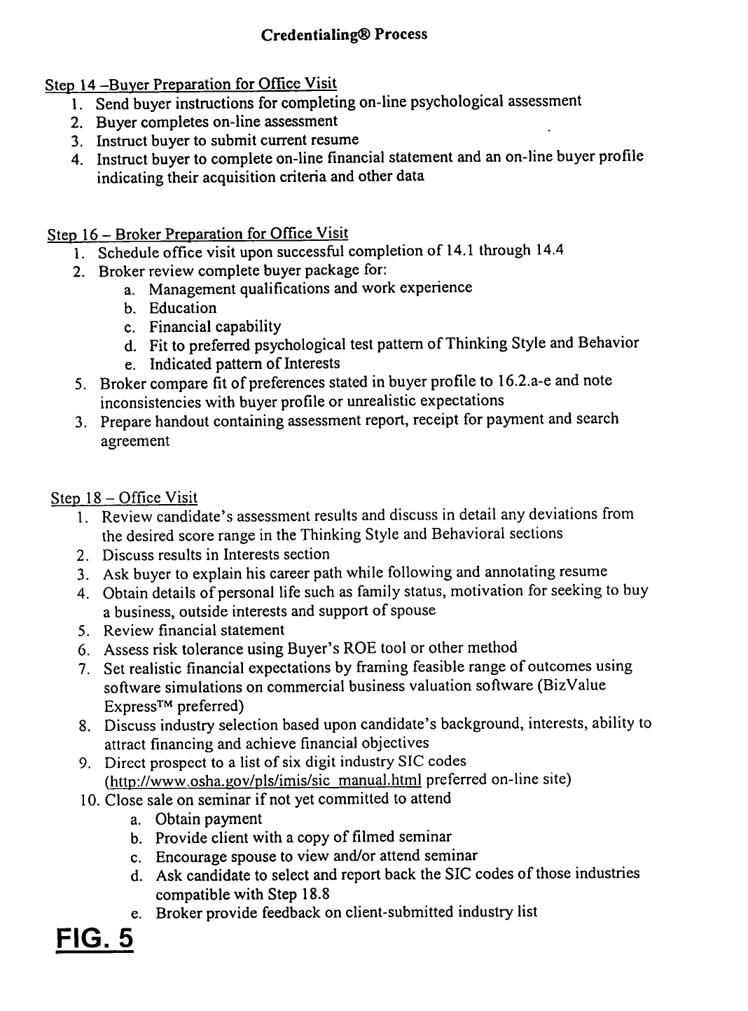

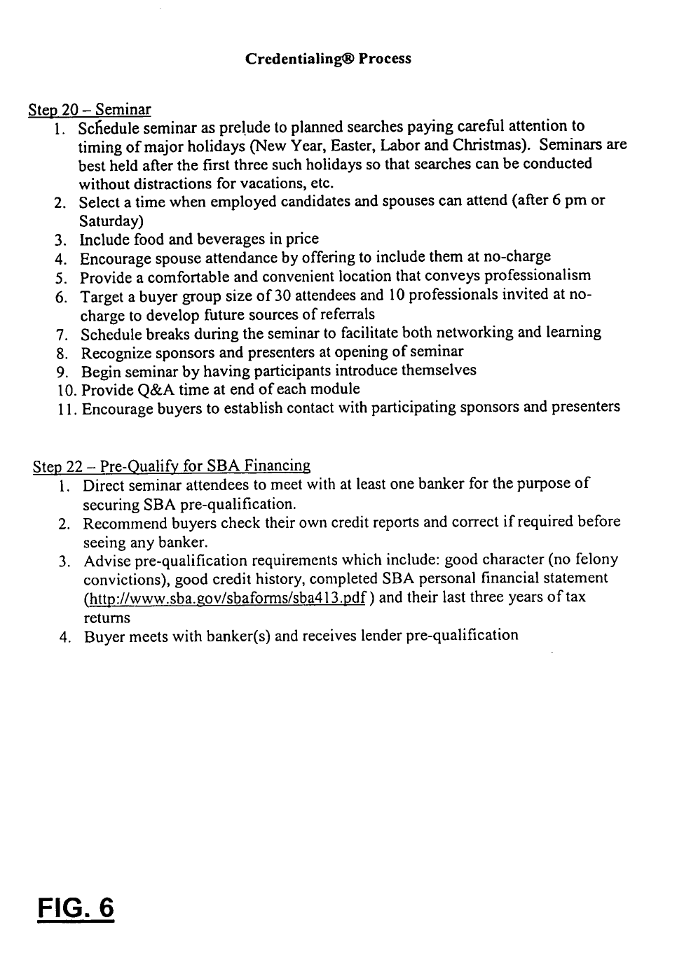

FIGS. 4-6 illustrate detailed sub-steps within each of the steps shown in the Credentialing® process shown in FIG. 1.

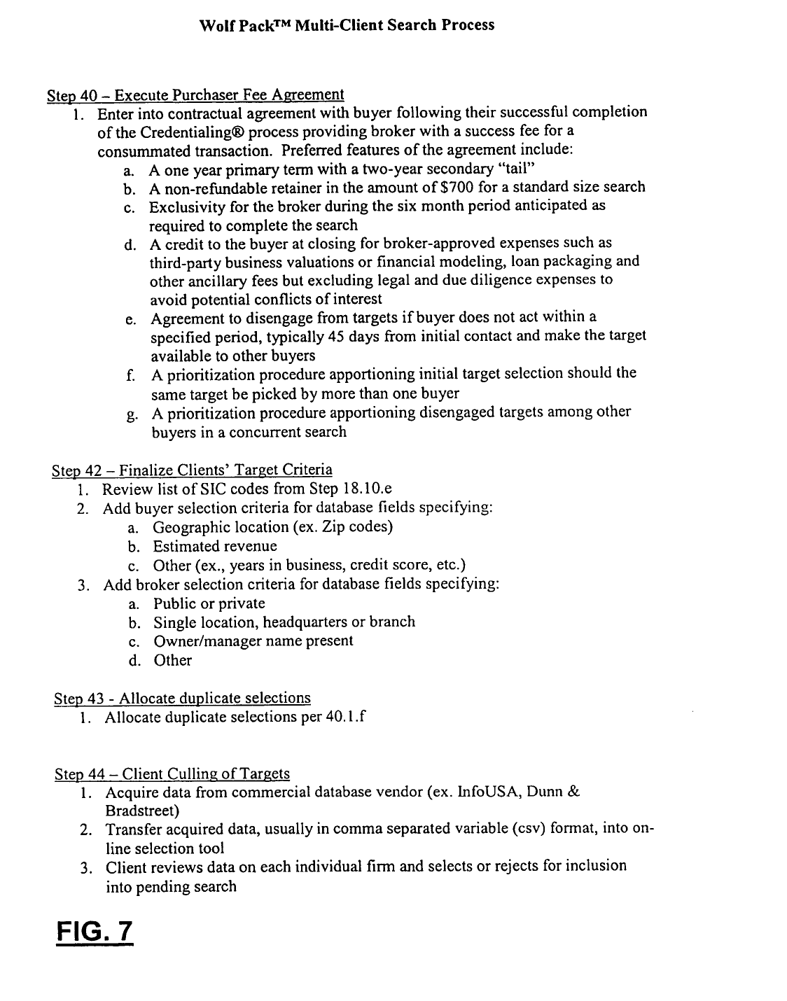

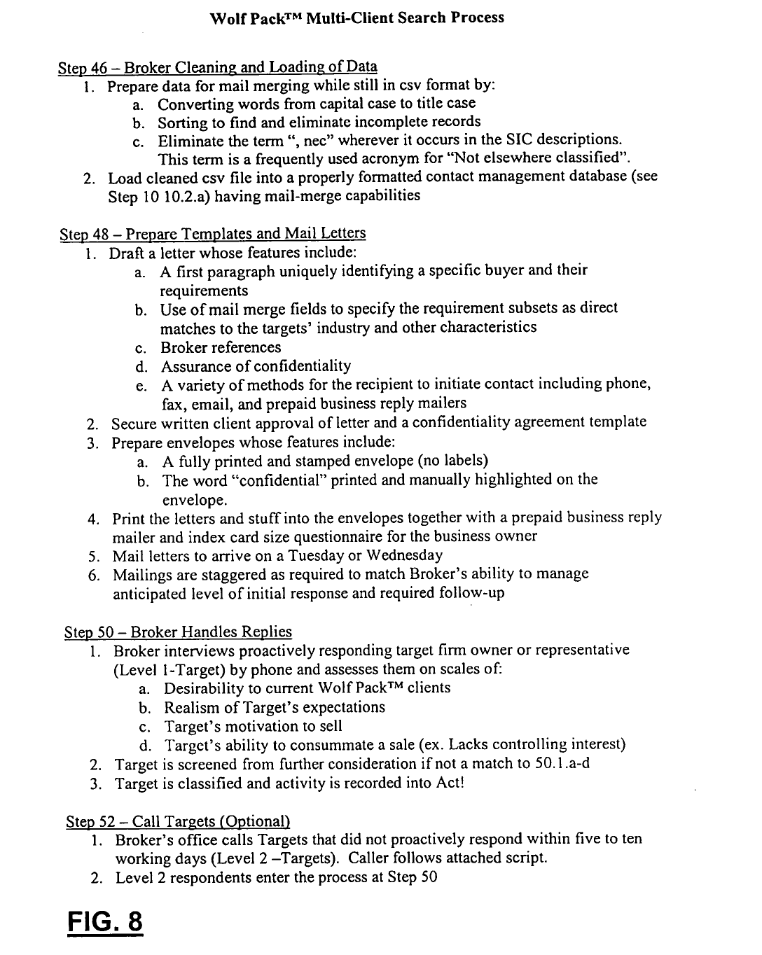

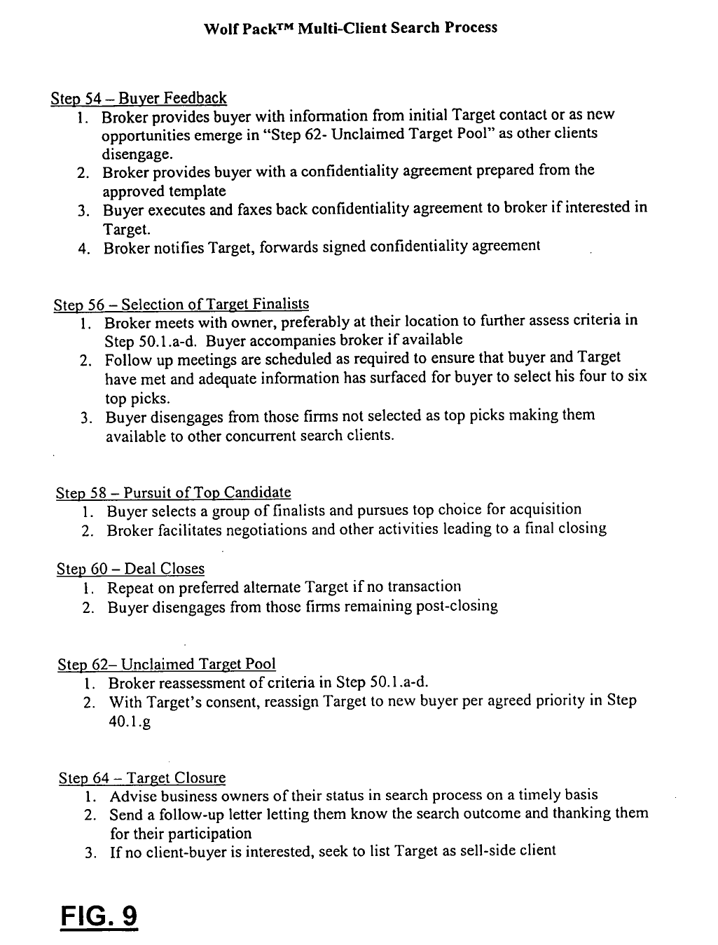

FIGS. 7-9 illustrate detailed sub-steps within each of the steps shown in the Wolf-Pack™ Multi-Client search process shown in FIG. 2.

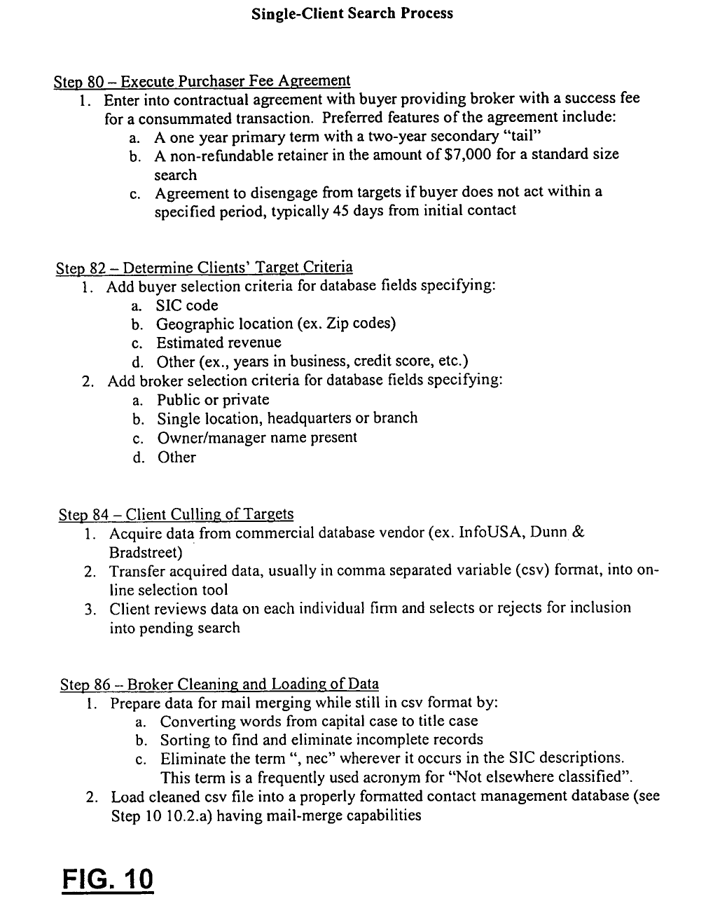

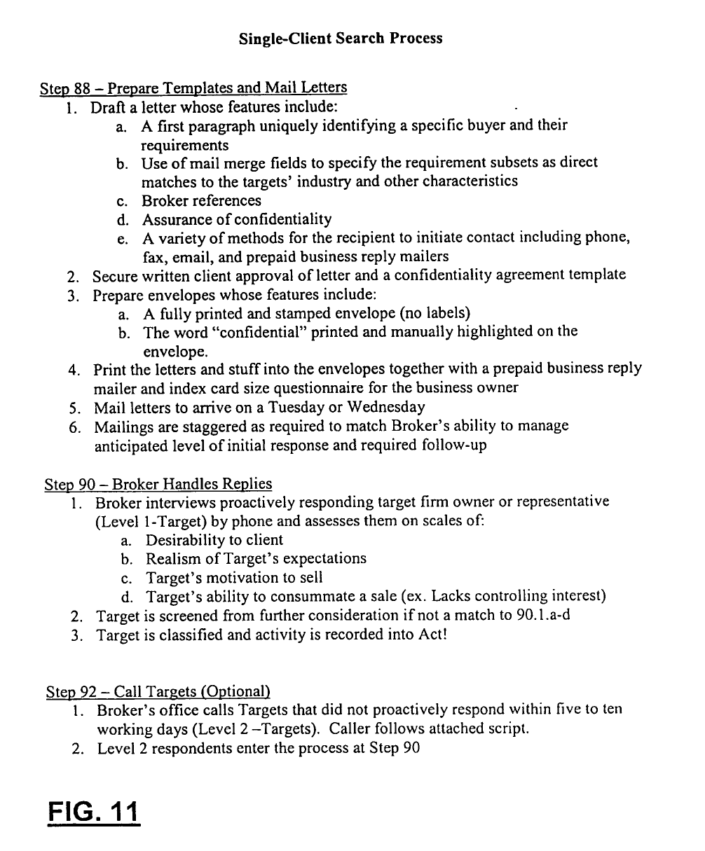

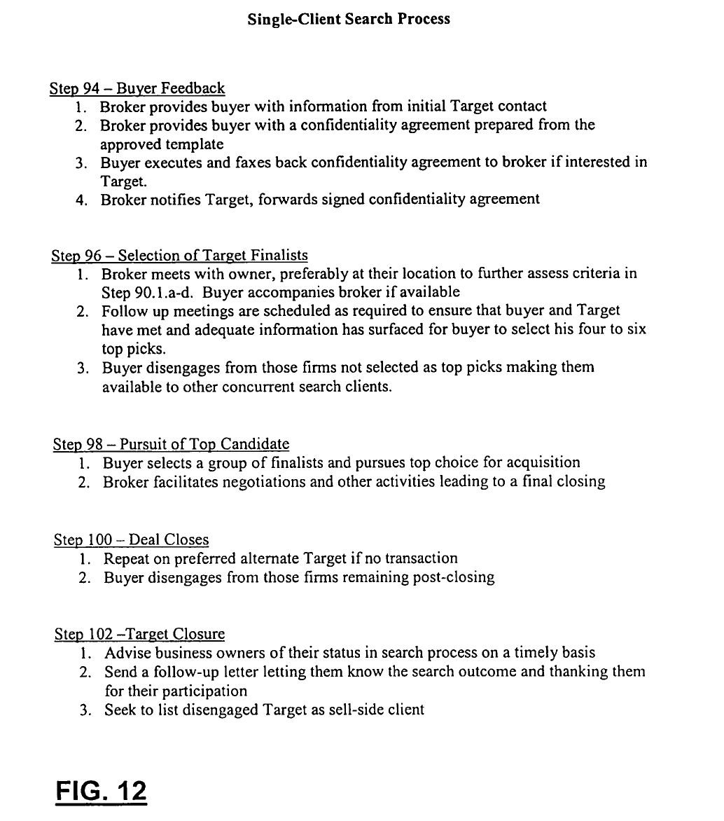

FIGS. 10-12 illustrate detailed sub-steps within each of the steps shown in the Single-Client search process shown in FIG. 3.

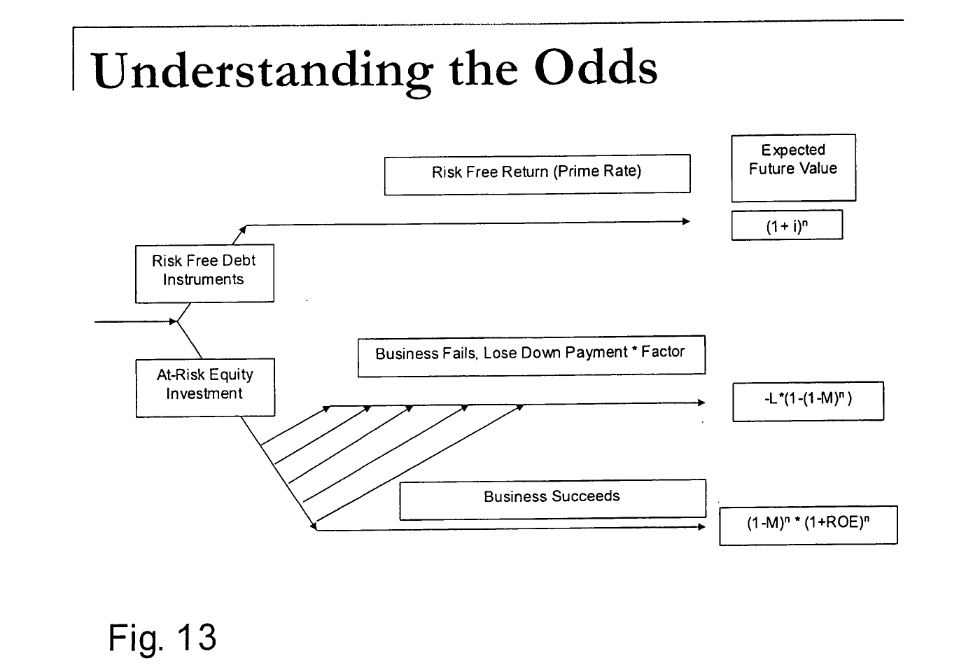

FIG. 13 illustrates a methodology diagram of risk of business ownership. This diagram tool was developed to demonstrate the high risk of business ownership to buyers. The diagram of FIG. 13 is mathematically classified as an “Expected Monetary Value” or “Decision Tree” process. The diagram calculates the required rate of return such that the buyer would be indifferent on the average to selecting the risk-free or at-risk path.

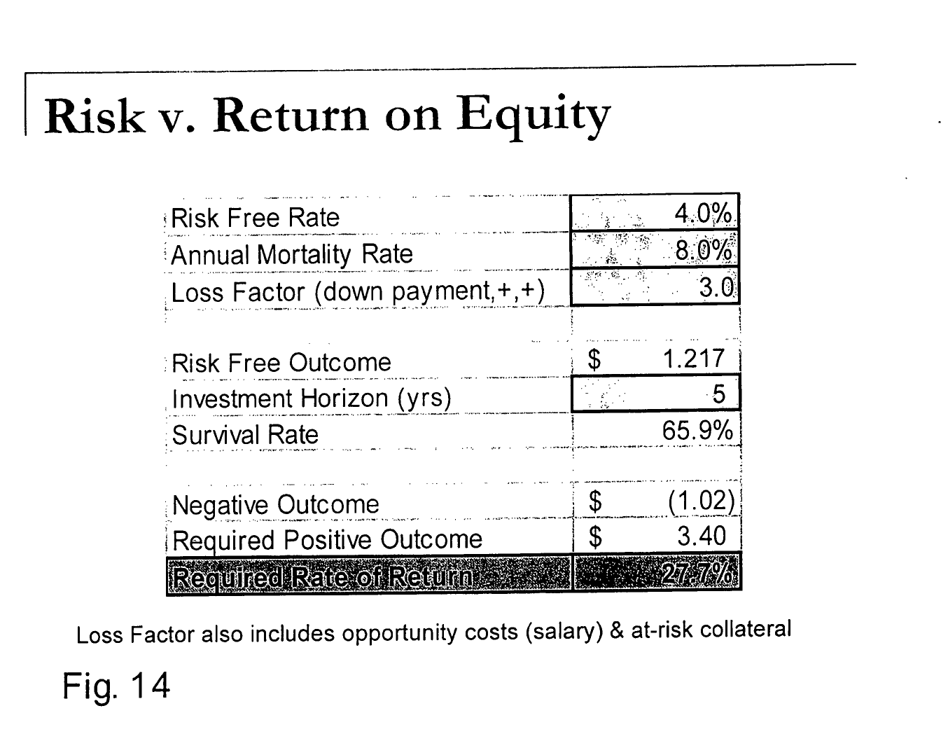

FIG. 14 illustrates a spreadsheet that embodies the calculation of the diagram shown in FIG. 13. The default setting shown in FIG. 14 uses realistic criteria based upon the United States Small Business Administration lending loan portfolio performance measures and the standard investment time frame of five years. The risk factor is influenced by down-payment, personal guarantees and opportunity cost.

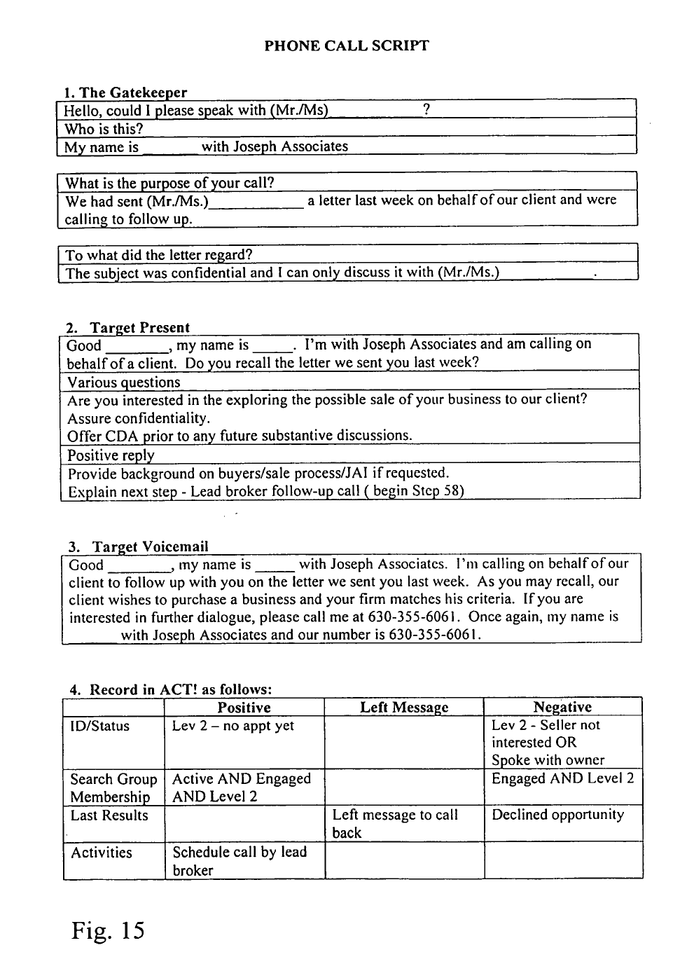

FIG. 15 is an example of a script to be used in the Wolf-Pack™ Multi-Client search process shown in FIG. 2.

We Claim As Our Invention:

1. A method for screening a prospective business buyer, said method comprising the steps of:
administering a psychological assessment to a prospective business buyer; and
generating a quantitative comparison of the prospective business buyer's psychological profile verses a target profile representing a pattern of previous successful buyers.

2. The method of claim 1, wherein the psychological assessment is administered using a computer via an internet connection with the prospective business buyer.

3. The method of claim 1, further comprising the step of:
determining the prospective buyer's level of risk tolerance.

4. The method of claim 3, wherein the prospective buyer's level of risk tolerance is determined using a risk of business ownership methodology.

5. A method for screening and enabling a prospective business buyer, said method comprising the steps of:
administering a psychological assessment to a prospective business buyer to create a psychological profile;
meeting with the prospective business buyer to review the prospective business buyer's psychological profile;
assessing risk tolerance of the prospective business buyer; and
assessing education level and job experience of the prospective business buyer, thereby enabling the prospective business buyer to better understand the prospective business buyer's chance for success as an entrepreneur and determine a business area suitable to the prospective business buyer.

6. A method for screening and enabling a prospective business buyer, said method comprising the steps of:
administering a psychological assessment to a prospective business buyer;
attending a seminar on purchasing a business; and
meeting financial people to prequalify for business acquisition financing.

7. The method of claim 6, further comprising the step of:
coaching the prospective business buyer to determine entrepreneurship is suitable based on available data and office interview.

8. A method for screening and enabling a prospective business buyer, said method comprising the steps of:
administering a psychological assessment to a prospective business buyer;
generating a quantitative comparison of the prospective business buyer's psychological profile verses a target profile representing a pattern of previous successful buyers; and
reviewing the psychological assessment and quantitative comparison with the prospective business buyer and their spouse.

9. The method of claim 8, further comprising the step of:
attending a seminar on purchasing a business by both the prospective business buyer and their spouse.

10. A business brokerage method for representing prospective business buyers, said method comprising the steps of:
administering a psychological assessment to a prospective business buyer;
collecting data on prospective business acquisition targets; and
culling the data on prospective business acquisition targets by the prospective business buyer, thereby enabling a proper fit with requirements of the prospective business buyer and enabling a business broker to communicate to target businesses that the prospective business buyer selected the target business for contact by the business broker.

11. The method of claim 10, further comprising the step of:
mailing inquiry letters to the target businesses.

12. The method of claim 11, wherein an inquiry letter includes a pre-addressed and postage paid return envelope, and a confidential marking on the return envelope.

13. The method of claim 11, wherein an inquiry letter includes a paragraph uniquely identifying a specific buyer and their requirements.

14. The method of claim 11, further comprising the step of:
using mail merge fields to specify prospective business buyer requirement subsets as direct matches to the target business industry and other characteristics.

15. The method of claim 11, wherein the inquiry letter includes business broker references.

16. The method of claim 11, wherein the inquiry letter includes a statement assuring confidentiality to the target business receiving the inquiry letter.

17. The method of claim 11, wherein the inquiry letter includes various communication mediums for the target business receiving the inquiry letter to initiate contact with the business broker.

18. The method of claim 11, further comprising the step of:
making follow-up phone calls to target businesses who did not respond to the inquiry letter.

19. The method of claim 10, further comprising the step of:
reviewing list of Standard Industrial Classifications (SIC) codes to narrow target businesses.

20. The method of claim 11, further comprising the step of:
adding business broker selection criteria to narrow target businesses.
